(19) United States
(12) Patent Application Publication
(10) Pub. No.: US 2021/0190308 A1
(43) Pub. Date: Jun. 24, 2021

(54) LUMIAIRE WITH INTEGRATED AIR MULTIPLIER

(71) Applicant: PHILIPS LIGHTING HOLDING B.V., EINDHOVEN (NL)

(72) Inventors: Antonius Adrianus Maria MARINUS, EINDHOVEN (NL); Simon Eme KADIJK, EINDHOVEN (NL); Mercedes CREGO CALAMA, EINDHOVEN (NL); Alexander Henricus Waltherus VAN EEUWIJK, EINDHOVEN (NL)

(21) Appl. No.: 16/076,068

(22) PCT Filed: Feb. 15, 2017
(86) PCT No.: PCT/EP2017/053399

§ 371 Date: Aug. 7, 2018

(30) Foreign Application Priority Data
Feb. 22, 2016 (EP) 16156720.1

(51) Int. Cl. F21V 33/00; F21V 23/04; F21V 29/60

(52) U.S. Cl. CPC F21V 33/0096; F21S 8/06; F21V 29/60; F21V 23/0442

(57) ABSTRACT

The invention provides a system (1) comprising a fan assembly (100) with a plurality of nozzle openings (115a, 115b, . . . ) for creating air flows (111a, 111b, . . . ), the fan assembly (100) configured to provide said air flows (111a, 111b, . . . ) in at least two non-parallel directions (112a, 112b, . . . ), wherein the at least two non-parallel directions (112a, 112b, . . . ) are configured within a virtual cone (30) having an apex angle (a) selected from the range of 10-170° and having a cone axis (31), a control system (200) configured to control said air flows (11a, 111b, . . . ), the system (1) further comprising a light source (10) configured to generate light source light (11).

### FIELD OF THE INVENTION

The invention relates to a system comprising a fan for ventilation of e.g. a room as well as to a method for creating an air flow in e.g. such room, for instance for cooling purposes.

### BACKGROUND OF THE INVENTION

Ventilators or fans are known in the art. A specific example is e.g. displayed in WO2014/165733. The document describes amongst others an automated luminaire creating a directable beam of light with an airflow generator which generates an air stream along the light beam. The beam of light and the airstream are coaxial.

### SUMMARY OF THE INVENTION

Fan assemblies known in the art in general have relative large propellers. Such propellers are not always perceived as esthetically desired. Further, such propellers are large moving parts which limit the accessible space, thus e.g. limit the free space on a ceiling for other devices, such as lighting devices. Further, such moving propellers potentially pose a risk for humans.

Fan assemblies can be used for cooling, as the breeze or air flow(s) generated by such fan assemblies provide a cooling effect on humans. Some of the above described problems associated with fan assemblies may be overcome by using an air condition or climate control. However, a disadvantage of such solution is the relative high energy consumption.

Hence, it is an aspect of the invention to provide an alternative fan assembly, which preferably further at least partly obviates one or more of above-described drawbacks, and which especially substantially does not necessarily compete with the space desired for other (pendant) devices, such as luminaires. It is also an aspect of the invention to provide an alternative method to provide a flow of air in a space, which preferably further at least partly obviates one or more of above-described drawbacks, and which method especially also includes the option of providing lighting and/or air purification, wherein space and/or energy are economically used.

In a first aspect, the invention provides a system (“system”) comprising a fan assembly with a plurality of nozzle openings for creating air flows (also indicated as “flows”), the fan assembly configured to provide said air flows in at least two directions, even more especially at least two non-parallel directions, wherein the airflow is at least twenty times larger than needed for cooling of the light source, preferably at least fifty times larger. It appeared that the system according to the invention renders the advantage that this implements a breeze or air flow(s) generated by such fan assemblies which provide a cooling effect on humans, yet without disadvantage of known air condition and climate control systems of a relative high energy consumption. Especially, the at least two non-parallel directions are configured within a virtual cone having an apex angle and having a virtual cone axis (“cone axis”), with the apex angle especially selected from the range of 10-170°. Hence, especially the at least two air flows are mutually divergent. Further, the system may especially further comprise a control system configured to control said air flows. The system especially further comprises in embodiments a light source configured to generate light source light, which may optionally also be controlled by the control system.

In more detail, the airflow is substantially larger, i.e. at least 20, such as at least 50 times larger than needed for cooling the light sources, i.e. to keep the light sources at a temperature at which the light source on average reaches the useful lifetime indicated for/on said light source. Prolonged heat can significantly shorten the useful lifetime of many solid state light sources, such as LEDs. Higher ambient temperature leads to higher junction temperatures, which can increase the degradation rate of the LED junction element, possibly causing the light output of an LED to irreversibly decrease over the long term at a faster rate than at lower temperatures. Controlling the temperature of an LED is, therefore, one of the most important aspects of optimum performance of LED systems. For example for Luxeon K2 white LEDs, an increase in junction temperature from 115° C. to 125° C. will shorten the useful lifetime of the LED to about 70% of the nominal, indicated lifetime.

Therefore, the invention may hereby realize a system (such as especially an apparatus), having an integrated luminaire and fan, especially air multiplier, which may e.g. be positioned in a horizontal plane, e.g. pendant, which may have an attractive appearance, which may cool both the luminaire and a human in the environment (especially with a guided powerful divergent air flow), and which may not have visible moving parts. The system may further provide various jets to different directions, which may especially independently be controlled. The system, especially with no visible moving parts, may be easy-to-clean and may be a safe product. The system may be configured to create direct- and/or indirect-illumination and may provide a powerful divergent air flow to cool human beings in the environment. The mutually divergent air flows may especially be realized by emitting the jets under an angle of at least 5°, even more especially at least 10°, such as in specific embodiments at least 20°, with respect to a central axis (or main axis) of the fan assembly or the cone axis, such as via an open area in the lighting appliance. The system may produce low audible noise. The infra structure of the energy network within a home, or other places, advantageously allows a combination of lighting and cooling of the persons in the environment. Especially, in countries where is often warm this is an interesting opportunity. The combination of lighting and cooling leads to the reduction of parts and space.

As indicated above, in embodiments the system comprises a fan assembly and a light source. The former is configured for creating one or more, especially a plurality of air flows; the latter is especially configured to provide light source light, such as for illuminating a space (wherein the system is configured). In embodiments, the term “system” may especially refer to an apparatus. Hence, in specific embodiments the invention relates to a system comprising an apparatus, the apparatus comprising the fan assembly and the light source in an integrated unit.

The fan assembly especially has a plurality of nozzles for creating air flows. Each nozzle may include at least one nozzle opening. Hence, the plurality of nozzles comprise a plurality of nozzle openings. Therefore, in embodiments the system comprises a fan assembly with a plurality of nozzles for creating air flows, wherein the plurality of nozzles comprise a plurality of nozzle openings. With a plurality of nozzle openings, a plurality of air flows can be created. The system thus comprises a plurality of nozzle openings. Here, the term “plurality” refers to two or more, such as three or more, and especially at least four or more. For instance, would the system be pendant over a table, four air flows may be generated to four sides of a table (configured below the system).

As indicated above, the fan assembly is especially configured to provide air flows in at least two non-parallel directions. Note that when the system is configured to provide more than two air flows, it is not necessarily excluded that there are air flows with parallel or substantially parallel directions. However, from the more than two air flows, at least two are configured with non-parallel directions. Note that the system may in embodiments be configured to provide a plurality (n) of flows with a plurality (k) of non-parallel directions, wherein n is at least 2, wherein k is at least 2, and wherein especially k may be between 2 and n. Especially, n is at least 3, even more especially n is at least 4. Further, k is also at least 3, even more especially at least 4, respectively. Herein, “n” is further used to indicate the number of air flows.

Hence, the system is especially configured to provide two or more air flows with diverging directions. To this end, the system comprises a fan assembly with two or more nozzle openings (see also below). The phrase “air flows in at least two non-parallel directions” may thus especially imply that vectors indicating the directions of at least two air flows are configured non-parallel. Herein, non-parallel thus implies an angle larger than 0°. State of the art system, such as provided by Dyson seem to generate an air flow wherein within the air flow the direction of the air flow is substantially everywhere parallel. Therefore, the directions of the airflow within the flow can be configured within a virtual cylinder.

Herein, especially the at least two non-parallel directions are configured within a virtual cone having an apex angle selected from the range of 10-170° and having a cone axis. A cone is a three-dimensional geometric shape that tapers smoothly from a flat base to a point called the apex or vertex. The apex angle is the angle between the lines that define the apex. Now, this apex angle is selected from the range of 10-170°. Hence, in fact the at least two non-parallel directions are configured within a first virtual cone having an apex angle selected from the range of at least 10° and within a second virtual cone having an apex angle selected from the range of at maximum 170°. This is herein also defined as “the at least two non-parallel directions are configured within a virtual cone having an apex angle selected from the range of 10-170°”. As indicated above, the definition does not exclude that there may be flows provided outside this virtual cone, but at least two air flows are configured within this virtual cone. Again, especially a plurality of the air flows have directions within this virtual cone. With this definition, it is amongst others indicated that at least two flows are not parallel (lower limit of the apex cone is especially 10°) but also that at least two flow are not antiparallel (i.e. 180°) (upper limit of the apex cone is 170°). Hence, the phrase “air flows in at least two non-parallel directions” may thus also especially imply that at least two air flows do not have opposite directions. In general, all the air flows generated by the system will not provide a subset of airflows with opposite directions. However, in embodiments anti-parallel air flows may be generated with the system. For instance, a plurality of air flows may be generated within the above indicated virtual cone, which may e.g. allow the system to provide air flows in different direction in a direction of a table or a floor, etc., assuming a pendant configuration, but one or more other air flows may be generated in a direction of a ceiling.

Herein, the term “virtual cone” is applied, as the system itself does not need to have a conical shape. The system (or the apparatus or the housing) may substantially have any shape. However, the flow (mutually divergent) directions are defined with the means of the virtual cone. In embodiments, the system may be configured to provide two or more subsets of (mutually divergent) flows, with each subset with two or more flows of which at least two are defined with their mutually divergent flow directions relative to a virtual cone (as defined herein). Hence, in embodiments the term “virtual cone” may also refer to a plurality of virtual cones, wherein each virtual cone defines for a subset of (mutually divergent) flows the flow directions. Especially, the cone axes of such plurality of virtual cones are configured parallel. In yet other embodiments, the cone axes of two or more of such plurality of virtual cones are configured antiparallel.

In fact, the phrase “at least two non-parallel directions are configured within a virtual cone having an apex angle and having a cone axis, with the apex angle especially selected from the range of 10-170°” may also defined as the two directions confined by two virtual cones with cone axes coinciding (and pointing with the apex in the same direction), wherein a smaller virtual cone has an apex angle of at least 10° and with a larger virtual cone having an apex angle of at maximum 170°.

The system includes a fan assembly. The fan assembly may include a plurality of nozzles. Each nozzle may comprise one or more nozzle openings. Especially, each nozzle include a single nozzle opening. The fan assembly is especially configured to provide jets of air. The fan assembly is especially configured to provide an air multiplying effect or air knife effect, for the at least two air flows. An air knife may consists of a high-intensity, uniform sheet of laminar airflow, sometimes known as streamline flow. Two or more of the air flows may be air knifes.

In specific embodiments, the nozzle openings have one or more (smallest) dimensions selected from a length, a width and a diameter in the range of 0.2-10 mm, especially 0.5-5 mm, such as 1-5 mm. Note that the nozzle openings are not necessarily round. Choosing one or more dimensions relatively small, such as 0.2-10 mm, like 0.2-5 mm, like 1-5 mm, an air flow with a jet character may be provided. Hence, there is at least a smallest dimension in the range of 0.2-10 mm. For instance, a slit with such width, but with a length of 10-100 cm may be applied. Hence, for non-circular nozzle openings not all dimensions are necessarily small. The total area provided by the nozzle openings (sum of cross sectional areas at the nozzle openings) may be at least 20 cm2, such as at least 40 cm2, like at least 50 cm2, such as in the range of 20-500 cm2, such as 20-250 cm2, like 50-150 cm2.

Further, especially the fan assembly comprises an air flow generating device, such as an impeller, configured to provide air flows with a high air flow and/or high air velocity. Especially, the fan assembly is configured to create air flows with a product of the air flow (m3/s) and the air velocity (m/s) of at least 0.05 m4/s2 through the nozzle openings, such as at least 0.1 m4/s2 through the nozzle openings, like at least 1 m4/s2 through the nozzle openings. Hence, the air flow(s) provided by all nozzle openings has a product of the air flow (m3/s) and the air velocity (m/s) of at least 0.05 m4/s2. Note that herein air flow in general refers to the flow of air, whereas in the air flow, as indicated in the preceding sentence, it also relates to a flow speed. Especially, the air flow generated by all nozzles is in the range of at least about 0.005-0.2 m3/s, especially −0.01-0.1 m3/s and/or the air velocity per nozzle is at least in the range of about 1-5 m/s, especially 3-30 m/s. Of course, during use one or more nozzle openings may not provide an air flow. Further, during use air flow and/or air velocity may also be reduced for one or more air flows. However, the fan assembly is at least able to create a product of the air flow (m3/s) and the air velocity (m/s) of at least 0.05 m4/s2 by all nozzle openings together.

With such air flows, a human may perceive the air flow as cooling. Hence, the system may e.g. be used for cooling purposes, like a state of the art fan. However, in contrast to state of the art fans, wherein rotating elements of the fan assembly may be visible to a user, such as a propeller or blades, in the present invention the air flow generating device, or at least the moving parts thereof, such as blades or a fan, is (are) hidden within the system. Hence, the air flow generating device may include e.g. an impeller. Hence, in specific embodiments, the fan assembly is configured to create air flows with a product of the air flow (m3/s) and the air velocity (m/s) of at least 0.05 m4/s2 through the nozzle openings, wherein the nozzle openings have one or more (smallest) dimensions selected from a length, a width and a diameter in the range of 0.2-10 mm, such as 0.5-10 mm, and wherein the fan assembly especially comprises one or more impellers. Hence, especially the product of the air flow (m3/s) and the air velocity (m/s) is an integrated value over all nozzle openings (that are configured to create the two or more mutually divergent air flows).

The fan assembly may also comprise an air inlet. The term “air inlet” may also refer to a plurality of air inlets. The flow generating device may especially suck air via the air inlet into the fan assembly and eject via a nozzle opening out of the fan assembly. The air inlet(s) and nozzle opening(s) may be in fluid communication via a duct. The fan assembly may include a plurality of ducts. One or more air inlets may be in communication with a plurality of nozzle openings and/or a plurality of air inlets may be in communication with one or more nozzle openings.

Herein the term “air flow generating device” may also refer to a plurality of air flow generating devices. Further, the term “impeller” may also refer to a plurality of impellers. Each nozzle may be functionally coupled to an impeller. However, an impeller may also serve two or more nozzles. Hence, the system may also include one or more valves, such as for controlling the air flows.

The fan assembly may be incorporated in a housing. The housing may comprise the nozzle openings for providing the air flows. Further, the housing may comprise one or more air inlets, with the fan assembly configured to suck air into the inlets and eject the air as air flows out of the nozzle outlets. In this way, moving parts within the housing may not be visible to a user. Especially, a single housing may include both the fan assembly and the light source, with the housing including one or more air inlets and the one or more nozzle openings, and the housing especially including a light exit window (for escape of light source light from the housing).

The system may include a switch, or a plurality of switches to control the flows, especially switches configured to selected between providing a flow and not providing a flow for one or more of the flows that can be generated with the system. Such switch(es) may be integrated in the system. Hence, the system may include an integrated circuit configured to allow a user select via switches to switch on or off one or more flows.

In further embodiments, however, the system may (also) include a control system configured to control said air flows. The term “control system” may especially refer to a device, or set of devices, that manages, commands, directs or regulates the behavior of another device or system. Here, the other device or system includes at least the fan assembly. The control system may include a remote control, configured to control the air flows. The control system, such as especially the remote control, may include a (graphical) user interface, especially configured to selected between providing a flow and not providing a flow for one or more of the flows that can be generated with the system, especially for a plurality of the flows. Further, the control system may also be configured to control one or more of the air flow and air velocity (see also below) of one or more of the flows, especially of at least two of the plurality of flows, such as all (n) air flows. In embodiments, the control system may be configured to control one or more of the air flow and air velocity in a continuous way. Hence, especially the control system is configured to control one or more of the flow velocity and flow rate of each of the at least two air flows escaping from the plurality of nozzle openings, such as at least two (of the plurality) of nozzle openings. Hence, in embodiments the system may also include also one or more of a mode wherein only light source light is provided, a mode wherein only one or more air flows are provided, a mode wherein substantially only air is purified. Hence, during use, for instance, only one nozzle may provide the air flow, though the system may also be set in a mode wherein the two or more mutually divergent air flows are provided.

In yet a further specific embodiment, the control system is configured to control the fan assembly and/or light source (see also below) as a function of an input signal of a user interface. This user interface may be integrated in an apparatus or device, such as in the housing, but may also be remote thereof (remote control; see also above). Hence, the user interface may in embodiments be integrated in an apparatus or device comprising the fan assembly and/or light source, but may in other embodiments be separate therefrom. The user interface may e.g. be a graphical user interface. Further, the user interface may be provided by an App for a Smartphone or other type of communication device, such as an android device, including an iPhone.

The control of both the light source and the fan assembly can be smart. Possible control functions for the light assembly may include one or more of intensity control, control of a direct and/or indirect beam (e.g. with a mirror by switching on and off different light sources), color control of one or more beams, etc. Further, possible control functions for the fan assembly may include one or more of speed of the jet, direction of the jet, etc. (see also above). For instance, the fan assembly may also include one or more valves configured to direct one or more air flows. The valves may be configured within a nozzle opening, upstream of a nozzle opening or downstream of a nozzle opening.

Therefore, the invention also provides (in a further aspect) a computer program product, optionally implemented on a record carrier (storage medium), which when run on a computer executes the method as described herein (see below) and/or can control the system as described herein.

The system may also include one or more sensors, such as motion sensor, with the control system configured to control the fan assembly and/or the light source (see also below) in dependence of a sensor signal of the sensor. The system may include a temperature sensor. The system may also include a dust particle sensor. The system may also include a humidity sensor. The system may also respond to a sensor signal from a sensor (such as one or more as herein described) configured external from the system. Therefore, in embodiments the system may further comprise a sensor, wherein the control system is especially configured to control one or more of (a) one or more of the air flows and (b) the light source light as function of a sensor signal of the sensor wherein the sensor is selected from the group consisting of a temperature sensor, an ambient light sensor, a humidity sensor, and an air quality sensor, etc. The term “sensor” may also relate to a plurality of different sensors. With such embodiments, e.g. the flow may be controlled as function of temperature. When the temperature is high, the fan assembly may provide stronger flows (e.g. when a human is detected with a presence sensor). With such embodiments, e.g. the flow may be controlled as function of air quality. A flow may be switched on or increased when the air quality has to be improved. With the (optional) filter, particles in air may be filtered out of the air (by the recirculation of air (with the apparatus)).

As indicated above, the system may further comprise a light source configured to generate light source light. The light source is especially configured to provide visible light, such as white light. The light source may also be configured to provide colored light. Further, the light source may be configured to provide light with a variable color and/or color temperature. The light source may have a variable intensity. As indicated above, when a control system is comprised by the system, the control system may also be configured to control the light source. Hence, a user may be able to control the different air flows and the light source. Hence, e.g. cooling with the air flow, light intensity, color of the light, etc. may in embodiments be controlled (via a user interface) with the control system.

The light source may especially include a solid state light source. The term “light source” may also refer to a plurality of light sources, such as 2-512 (solid state) LED light sources. Hence, the term LED may also refer to a plurality of LEDs. The light source may thermally be coupled with a heat sink, such as physically associated with the heat sink. The fan assembly may also cool the light source and/or heat sink. However, the air flows provided are especially substantially larger (than necessary for cooling the light source(s)) and (further) provided as mutually divergent air flows escaping from the system.

The system may include a light exit window, with the light source configured upstream of the light exit window. When a plurality of light sources are available, there may be the same number of light exit windows or less. A plurality of light sources may be configured upstream of a single light exit window, with light source light of the plurality of light sources transmittable through the (shared) light exit window. A light exit window comprises light transmissive material, transmissive for the light source light. Especially, the housing comprises one or more of such windows, with the light source(s) configured within the housing, especially for providing light source light to ambient of the system via the light exit window.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

As indicated above, the system is especially configured to provide a plurality of air flows with air flow direction within a virtual cone. As also indicated above, the system may further include a light source configured to provide light source light. The light of the light source may emanate in a direction away from the system. The light source light may have an optical axis. In principle, the optical axis may have substantially any angle with the virtual cone axis. Even, the optical axis is not necessarily within the cone. Would the optical axis be within the cone, the system may especially be configured as downlighter. However, the light source may also provide light source light in a direction substantially perpendicular or opposite to at least two of the at least two (mutually divergent) air flows. For instance, the light source may be configured to provide light source light in a direction parallel to the cone axis, but without (direct) light in the cone. Such system may e.g. be used as uplighter.

Hence, in embodiments the light source light has an optical axis, and the system is configured to provide said light source light with the optical axis of the light source light and the cone axis having a mutual angle selected from the ranges of 0-80° (especially about 0°) and 100-180° (especially about 180°). In the former variant, the light source light is provided in the same (virtual) hemisphere as the air flows, even more especially in the same virtual cone; in the latter variant, the light source light is provided in another virtual hemisphere as the air flow, and is outside the virtual cone. The former variants may e.g. describe a downlighter (and also down(wards) fan); the latter variant may e.g. describe an uplighter (but down(wards) fan).

Hence, in embodiments the air flows and the light source light may be provided in a same hemisphere. In other embodiments, the air flows and the light source light may be provided in different hemispheres (such as an uplighter and a downwards directed fan (i.e. airflows directed downward)). However, the invention may also include embodiments wherein both the light source light and air flows may be directed upwards. In yet further embodiments, the airflows may be directed downwards and light source light is also directed downwards, but another lighting device provides light directed upwards. In yet further embodiments, the airflows may be directed upwards and light source light is also directed upwards, but another lighting device provides light directed downwards. In yet further embodiments, the airflows may be directed downwards, and a further airflow is also directed upwards, and optional light source light is directed downwards or upwards (or a plurality of light sources is configured light source light both downwards and upwards).

Therefore, in embodiments one or more air flows have directions that are not coaxial with the optical axis of the light source light, but have an angle with the optical axis of at least 5°, such as at least 10°, like at least 20°, but especially less than 90°, especially equal to or less than 85°. The angle of at least 5° may e.g. correspond to an apex angle of at 10° and the value of equal to or less than 85° may e.g. correspond to an apex angle of at maximum 170°.

Below, some further embodiments are described.

As mentioned above, the system is especially configured to provide at least two (divergent) air flows. Hence, in embodiments the system, or more especially the fan assembly, may comprise at least two nozzle(s) openings. In yet further embodiments, the system comprises at least three nozzle openings, wherein the fan assembly is configured to provide at least three air flows in at least three mutually non-parallel directions, and wherein the control system is configured to control one or more of the flow velocity and flow rate of each of the at least three air flows escaping from the at least three nozzle openings. With three air flows, one may provide more controllability to a user. For instance, only part of a room may be provided with a (cooling) breeze.

In specific embodiments the nozzle openings may be configured in a configuration that may be described as a (virtual) closed curve, such as a closed arc. The term “virtual closed curve” refers to a closed curve that is virtually present. Note again that a nozzle opening is not necessarily circular; a nozzle opening may also be rectangular. However, the nozzle opening may also have the shape of an arc segment, or of a segment of an elliptical arc, or other shape such as an oval arc. Such nozzle opening may be relatively narrow (see smallest dimension indicated above), but also be relative long, such as 10 cm or longer.

Hence, in embodiments two or more nozzles may be configured as a substantially closed curve. However, in yet other embodiments a plurality of nozzle openings is configured in a configuration that may be described as closed curve, where e.g. at least six circular nozzle openings are available. The virtual closed curve may be round, but is not necessarily round. In embodiments wherein the closed curve is round, an annular configuration may be obtained. Hence, in embodiments the plurality of nozzle openings are configured in an annular configuration. Therefore, in different ways a (kind of) ring shaped configuration of a plurality of nozzle openings is obtained. For instance, the light source may be configured such, that light source light escapes from at least part of the area enclosed by the (virtual) closed curve of nozzle openings, though alternatively or additionally, the light source may also be configured such that light source light escapes from a virtual curve enclosing the (virtual) closed curve of nozzle openings.

As indicated above, the system may especially have a light exit window from which light source light emanates (in a direction away from the light source). In specific embodiments, the light exit window may be configured in a configuration that may be described as a (virtual) closed curve. However, the light exit window may also have the shape of an arc segment, or of a segment of an elliptical arc, or other shape such as an oval arc. Hence, in embodiments, two or more light exit windows may be configured as a substantially closed curve. However, in yet other embodiments a plurality of light exit window s is configured in a configuration that may be described as closed curve, where e.g. at least six smaller light exit windows are available. The virtual closed curve may be round, but is not necessarily round. In embodiments wherein the closed curve is round, an annular configuration may be obtained. Hence, in embodiments the light source comprises an annular light exit window. Therefore, in different ways a (kind of) ring shaped configuration of a light exit window or a plurality of light exit windows is obtained. For instance, the light source may be configured such, that light source light escapes from at least part of the area enclosed by the (virtual) closed curve. For instance, the fan assembly may be configured such, that the air flows escape from at least part of the area enclosed by the (virtual) closed curve of the light exit window(s), though alternatively or additionally, the fan assembly may also be configured such that the air flows escape escapes from a virtual curve enclosing the (virtual) closed curve of light exit window(s).

Therefore, in embodiments (a) the plurality of nozzle openings may perimetrically (such as circumferentially) surround a light exit window, especially an annular light exit window, and/or the light source or (b) the plurality of nozzle openings are perimetrically (such as circumferentially) surrounded by a light exit window, especially an 0 annular light exit window and/or the light source.

Note that different perimetrical configurations may be possible, such as annular, but also square, rectangular, triangular, etc. etc.

In further embodiments, the system is especially configured to provide at least two air flows in different directions with a mutual angle of at least 10° (smallest virtual cone apex angle), more especially at least 20°. Note that when a large number of air flows with different directions is generated, adjacent airflows may have mutual angles that are relatively small, whereas there are still at least two air flows, or even more than two air flows, that have mutual angles (or more especially their directions have mutual angles) that are larger than 10°, especially larger than 20°. Therefore, in embodiments the system may have a main axis, wherein the optical axis is especially configured parallel to the main axis, and wherein the fan assembly is configured to provide said air flows in at least two non-parallel directions having angles with the main axis selected from the ranges of at least 5°, even more especially at least 10°, such as in the range of 20-70°. Two mutually divergent beams each having an angle of 10° especially have a mutual angle of 20° (virtual apex angle of 20°).

In addition to the lighting functionality or alternative to the lighting functionality, the system may also include an air filter(ing) functionality. Hence, in specific embodiments the fan assembly comprises an air flow generating device (see also above), wherein the fan assembly comprises a duct for a fluid connection between an air inlet and one or more nozzle openings, wherein the duct comprises an air filter. At least part of the duct may be comprised by the nozzle. Hence, the system may include an flow generating device and an air filter. In this way, air quality in a space can be improved. Hence, the system may also be configured for air purification (and optional lighting).

As a relative high air flow and velocity are desirable, the filter may have the undesired effect that the flow and/or velocity are impeded. It surprisingly appears that the filter function may still work well, when the filter (cross-sectional area) is smaller than the duct (cross-sectional area). Such embodiment may allow relative high air flows and/or velocities, whereas still part of the air is filtered. As in a space, such as a room, the air circulates, after some time the air may be filtered well without (substantial) loss of the cooling function. Hence, in embodiments the air filter has an air filter cross-section, wherein the duct has a duct cross-section at a position where the air filter is configured, and wherein the filter cross-section and the duct cross-section have a ratio selected from the range of 0.3-0.98, such as 0.3-0.95. However, the ratio can also be 1 (no by-pass effect). Optionally, the ratio is controllable, such as with a valve, or with a filter configured as a valve. The control system may in embodiments also control the ratio, such as in dependence of a sensor signal, such as of an air quality sensor.

The system may especially be configured as pendant system. Hence, in embodiments the system is especially configured for suspension. Especially, the system may comprise a top part and a down part, wherein the light source is configured to provide said light source light propagating in a direction away from one or more of said top part and said down part, and wherein the fan assembly is configured to provide said air flows propagating in a direction away from said down part.

With the system, it is possible to create unobtrusive air circulation (very) close to the location of human beings. Especially, this may be achieved by integrating the air circulation unit inside a system whereby the area of the outlet is substantially smaller than the area of the surface defined by the edges of the luminaire. Further, especially the system is designed as pendant. Hence, the system is especially be configured to be used as pendant. In embodiments, the outlet of the airflow(s) may be located at the periphery of the surface defined by the edges of the system (that is where the human beings may be expected to sit). Further, especially the air circulation unit is completely not visible from the outside; no rotating parts will substantially be visible for a human viewing the system when configured in (normal) use.

In specific embodiments, the system may have a filter function. The system may be indicated as luminaire and/or as fan and/or cooling device and/or as air filtration device (see also below).

Hence, amongst others the invention provides a lighting appliance with integrated fan assembly for illuminating directly and/or indirectly the environment and for creating an air current, e.g. to cool a human being in this environment. The lighting appliance may comprise at least one light source which may e.g. be mounted on a heatsink. The fan assembly comprises a wind engine, air ducts and one or more nozzles directed away from the center to realize (a) powerful airflow(s), e.g. to cool the human being in the environment. Especially, the fan assembly has no visible moving parts. Further, especially the jets may be emitted under a mutual angle of at least 10°, such as especially at least 20° with respect to a central axis of the fan assembly, for instance via an open area in the lighting appliances. The lighting appliance may especially be positioned in a horizontal plane, e.g. pendant, and can have at least two set of nozzles with different directions relative to the central axis, enabling selectively control of the jets. The light appliances with air multiplier may also comprise a filter module to realize air purification.

In yet a further aspect, the invention provides (also) a method for providing one or more of an air flow and light in a space, the method comprising providing one or more of (a) one or more air flows wherein the airflow is at least twenty times larger than needed for cooling of the light source, preferably at least fifty times larger, and (b) light source light in a space, especially with the system as defined herein. In yet a further embodiment, the invention provides (also) a method for providing an air flow in a space and optionally filtering air in said space, the method comprising providing one or more of said air flows, and optionally filtering with the herein described air filter, with the system as defined herein. Hence, in embodiments the system further comprises said air filter as described herein, wherein the method may (thus) further comprises filtering air in said space. Optionally, the system may also be applied for filtering of air only, with optionally the system not having a lighting function and/or not having a cooling function.

The term space may for instance relate to a (part of) hospitality area, such as a restaurant, a hotel, a clinic, or a hospital, etc. The term “space” may also relate to (a part of) an office, a department store, a warehouse, a cinema, a church, a theatre, a library, etc. However, the term “space” also relate to (a part of) a working space in a vehicle, such as a cabin of a truck, a cabin of an air plane, a cabin of a vessel (ship), a cabin of a car, a cabin of a crane, a cabin of an engineering vehicle like a tractor, etc. The term “space” may also relate to (a part of) a working space, such as an office, a (production) plant, a power plant (like a nuclear power plant, a gas power plant, a coal power plant, etc.), etc. For instance, the term “space” may also relate to a control room, a security room, etc. The term space may also relate to a room in a home, such as in a house, an apartment, etc. In specific embodiments, the system is configured over a seating area. However, in other embodiments, the system is configured over a sleeping area, a working area, or a relaxing area, etc.

As indicated above, with the system a single electricity point in a ceiling may be used to provide a system having one or more functionalities, especially two or more functionalities selected from the group consisting of cooling, lighting and air filtering. Hence, in further embodiments the system may be configured pendant. Hence, in embodiments the product may be positioned in a horizontal plane, e.g. pendant, and can have (at least) two set of nozzles with different directions relative to the central axis, enabling selectively control of the jets.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some embodiments of the system;

FIG. 2 schematically depict some uplight and/or downlight aspects;

FIGS. 3a-3c schematically depict some possible embodiments; and

FIGS. 4a-4e schematically depict some aspects and embodiments of the system and its application.

The schematic drawings are not necessarily on scale.

### DETAILED DESCRIPTION OF THE EMBODIMENTS

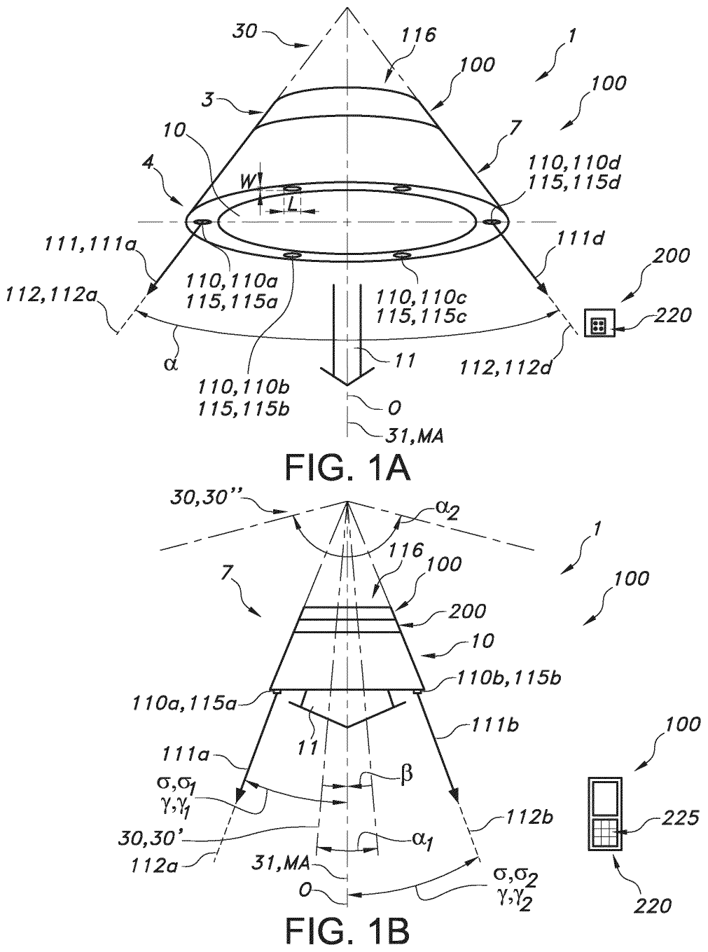

FIG. 1a schematically depicts an embodiment of a system 1 as described herein, which comprises a fan assembly 100 with a plurality of nozzle openings 115, which individual nozzle openings are indicated with references 115a,115b, . . . . The fan assembly is configured to create (mutually divergent) air flows 111a, 111b, . . . (from one or more of said nozzle openings).

Indications like “115a,115b, . . . ” indicate that at least two of such element may be available. Further, indications like “115a,115b, . . . ” indicate a plurality of the element 115, with the individual elements being indicated with 115a,115b, . . . .

During use, one or more air flows 111 may be generated. However, the system is configured to provide said air flows 111a, 111b, . . . in at least two non-parallel directions 112a, 112b, . . . . Though the system is configured to provide said air flows 111a, 111b, . . . in at least two non-parallel directions 112a, 112b, . . . , this does not imply that during use always all air flows are provided. For instance, one may switch between air flows, or reduce the number of air flows in a direction where no air flow is desired, etc. To that end the system may further include a control system (see also below).

The fan assembly 100 may include a plurality of nozzles 110, with the individual nozzles being indicted with references 110a, 110b, etc. Note that the air flow generating device (see also below) as well as the nozzles may substantially be enclosed by a housing 7, with only the nozzle openings 115 (optionally) visible. Here, the nozzle openings 115 are configured in a virtual closed arc, which may be round or oval. By way of example, six nozzle openings 115 are depicted. In this schematically depicted embodiment the plurality of nozzle openings 115a, 115b, . . . are configured in an annular configuration. The system may also comprise an inlet 116 (e.g. at the top of the system).

The nozzle openings 115 can substantially have any shape. Here, by way of example six nozzle openings 115 are depicted, which have an oval shape. In specific embodiments, the nozzle openings have one or more (smallest) dimensions selected from a length (L), a width W and a diameter in the range of 0.2-10 mm, especially 0.5-5 mm, such as 1-5 mm. Width W and length L are indicated in the drawing. The nozzle opening define a cross-sectional area. The total cross-sectional are for all nozzle openings 115 may be at least 20 cm2, such as even at least 50 cm2, to provide the desired flows.

In embodiments, the system 1 may further comprise a light source 10, such as a solid state light source, like a LED, configured to generate light source light 11. The light source light has an optical axis O. Here, the system 1 is configured as downlighter, though alternatively or additionally, the system 1 may also be configured as uplighter.

The at least two non-parallel directions 112a, 112b, . . . are configured within a virtual cone 30 having an apex angle α selected from the range of 10-170°, such as 20-120°, like 30-150°. A cone having a diameter twice as large as the length of the cone axis has a cone angle of 90°. The virtual cone further has a cone axis 31. The apex angle α can also be defined as a cone angle. The apex angle of the virtual cone 30 in FIG. 1a is about 75°.

Note that here the optical axis O and the cone axis 31 are parallel in this schematically depicted embodiment. Even more, in this embodiment the optical axis O and the cone axis 31 (substantially) coincide.

The system 1, as schematically depicted here is configured for suspension (pendant). The system 1 may comprise a top part 3 and a down part 4. The light source 10 is configured to provide said light source light 11 propagating in a direction away from one or more of said top part 3 and said down part 4, here in a direction away from the down part 4. However, especially the fan assembly 130 is configured to provide said air flows 111a, 111b, . . . propagating in a direction away from said down part 4.

The system 1 may further include a control system 200 configured to control said air flows 111a, 111b, . . . . The control system may be integrated in the housing 7 (as schematically depicted in FIG. 1b); or may be external thereof (as schematically depicted in FIG. 1a). Further, the control system 200 may include a user interface 220, which may be integrated in the system or which may be remote, such as comprised by a remote control (see also FIG. 1b). The control system 200 may further be configured to control the light source 10. The system may be equipped with sensors to sense the air quality for automatically performing air purification.

The system 1 may have a main axis MA, especially when the device may have a cylindrical like shape or a conical like shape or a beam like shape. The main axis MA may especially coincide with at least one virtual cone 30.

The system, or more especially the device depicted that comprises the fan assembly 100 and the light source 10, as schematically depicted in FIG. 1a is shaped like a cone and centered around a revolution axis, where a central opening or light exit window (see below) is centered around the axis. However, this shape of the system 1 or of the housing 7 is a non-limiting example of the many possible shapes. For instance, referring to FIG. 1b, this may be a cross-section of a conically shaped system 1, but this may also be the cross-section of a regular pyramid(-like) shape, such as a triangular shaped pyramid or a square (rhombic) pyramid or a rectangular pyramid, or a pentagonal pyramid, etc. etc.

One may also state that the at least two non-parallel directions 112 of the air flows 111 are defined by a first virtual cone 30′ and a second virtual cone 30″, one having a cone apex α1, which has the herein indicated lower value of at least 10°, and one having a cone apex α2, which has the herein indicated upper value of 170°. The air flows 111 have directions 112 within these two cones 30′,30″. The virtual cones 30′ and 30″ share the cone axis 31. This is schematically indicated in FIG. 1b. The apexes of the two virtual cones point in the same direction (here upwards). The apex angles in FIG. 1b are about 15° (α1) and 150° (α2).

As the first virtual cone 30′ has (thus) an apex angle of (at least) 10°, the angle of the air flows 111 is thus at least 5° with the virtual cone axis 30, such as at least 10°. Therefore, especially, such as also depicted schematically in FIG. 1b, the system (1) is configured to provide said air flows 111a, 111b, . . . having (mutual) angles al, 62, . . . with the cone axis 31 selected from the ranges of 5-85°, even more especially 10-80°. More especially, the directions 112a, 112b, . . . and the cone axis 31 have mutual angles σ1, σ2, . . . selected from the ranges of 10-80°, such as at least 20°, like in the range of 20-70°.

Here, the system 1 has again a main axis MA. The optical axis O is configured parallel to the main axis MA. The fan assembly 100 is configured to provide said air flows 111a, 111b, . . . in at least two non-parallel directions 112a, 112b, . . . having (mutual) angles γ1, γ2, . . . with the main axis MA selected from the ranges of 5-85°, even more especially 10-80°, more especially selected from the ranges of 20-70°. As in this embodiment the main axis MA substantially coincide with the virtual cone axis 31, the values for γ and σ may be (substantially) equal.

Further, the system 1 is configured to provide said light source light 11 with the optical axis O and the cone axis 31 having a mutual angle θ selected from the ranges of 0-80° and 100-180°. In FIG. 1b, the angle β is 0°; as the system is a downlighter and down fan.

In FIG. 1b, a remote control 225 is indicated, which may include a user interface 220 for providing instructions to the control system 200. Here, by way of example the control system 200 is integrated in the housing 7.

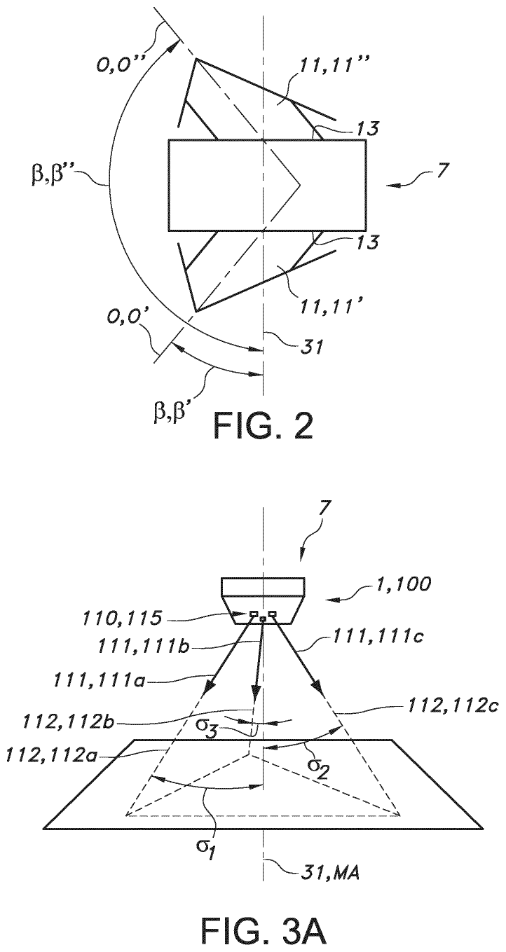

FIG. 2 schematically depicts the orientation of the optical axis relative to the cone axis 31. The light source light 11 with the optical axis O and the cone axis 31 have a mutual angle β selected from the ranges of 0-80° (downlight) and 100-180° (uplight). Only by way of example (two) beams are depicted that have non-zero angles β with the cone axis 31.

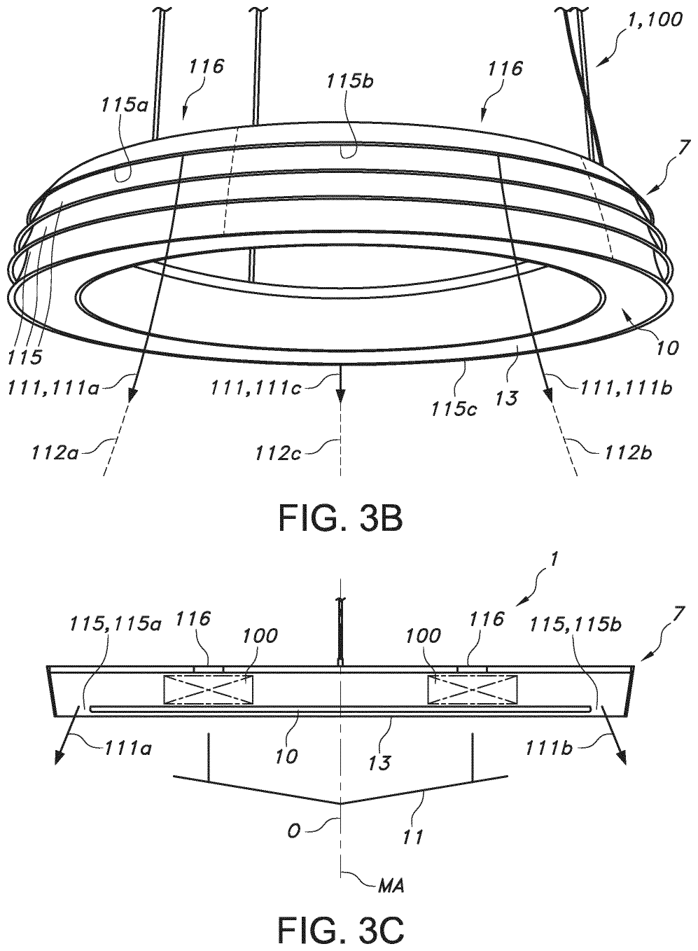

FIG. 3a schematically depicts an embodiment of the system 1 comprising at least three nozzle openings 115a, 115b, . . . , wherein the fan assembly 100 is configured to provide at least three air flows 111a, 111b, . . . in at least three mutually non-parallel directions 112a, 112b, . . . , and wherein the control system 100 is configured to control one or more of the flow velocity and flow rate of each of the at least three air flows 111a, 111b, . . . escaping from the at least three nozzle openings 115a, 115b, . . . . Note that each of the flow directions 112a, 112b, . . . have a mutual angle σ with the cone axis 31 of at least 10 such as at least 20°, though especially not larger than 80°. Note that the device or housing 7 has a square or rectangular cross-section.

As can be derived from e.g. FIGS. 1a, 1b and 3a, the system 1 may be configured to provide said air flows 111a, 111b, . . . and said light source light 11 with the optical axis O of the light source light 11 and one ore more directions 112a, . . . having mutual angles selected from the ranges of 10-80° and 100-170°. Further, also two or more flow directions may have mutual angles selected from the ranges of 10-80° and 100-170°. Especially, at least two or more flow directions have mutual angles selected from the ranges of 10-80°. Note that when a multitude of flow directions are available (in the same virtual cone), a plurality of subsets of two flow directions may comply with this condition, though adjacent flows may have flow directions that may have smaller mutual angles.

FIG. 3b schematically depicts an embodiment of the system 1 wherein the light source 10 comprises an annular light exit window 13. For instance, a plurality of solid state light source may be configured upstream from the light exit window 13 (solid state light sources not visible in the drawing). Here, the system 1 also comprises a plurality of annular nozzles openings 115. Here, by way of example three annular nozzles openings 115 are depicted over each other. Note that one or more of these nozzle openings may include a plurality of different nozzle openings 115a, 115b, . . . . This is schematically indicated in the upper annular nozzle opening, which includes in fact nozzle opening 115a (right), nozzle opening 115b (left), and a third nozzle opening 115c (at the back) of the housing. The dashed lines indicates the sections wherein the respective nozzle openings 115a, 115b, etc. are configured. Only by way of example schematically three sections are depicted. Also two, or more than three section may be used. The two other rings may provide further nozzle openings that may optionally be independently controlled form the nozzle openings 115a, 115b, 115c of the upper annular nozzle opening, but which may optionally also be subdivided in the same three sections. Note that here both the nozzle openings 115 are configured in an annular configuration and the light exit window is configured in an annular configuration.

FIG. 3c schematically depicts a similar type of embodiment as schematically depicted in FIG. 3b. However, here the light exit window 13 is not hollow but substantially closed. Hence, where in FIG. 3b the light exit window 13 is a closed arc, here the light exit window 13 is a closed circle, square, triangle, rectangle, etc., whatever shape is selected. References 116 indicate openings (air inlets) for sucking air into the fan assembly. As indicated above, the term “fan assembly” may also refer to a plurality of fan assemblies (that may independently be controlled).

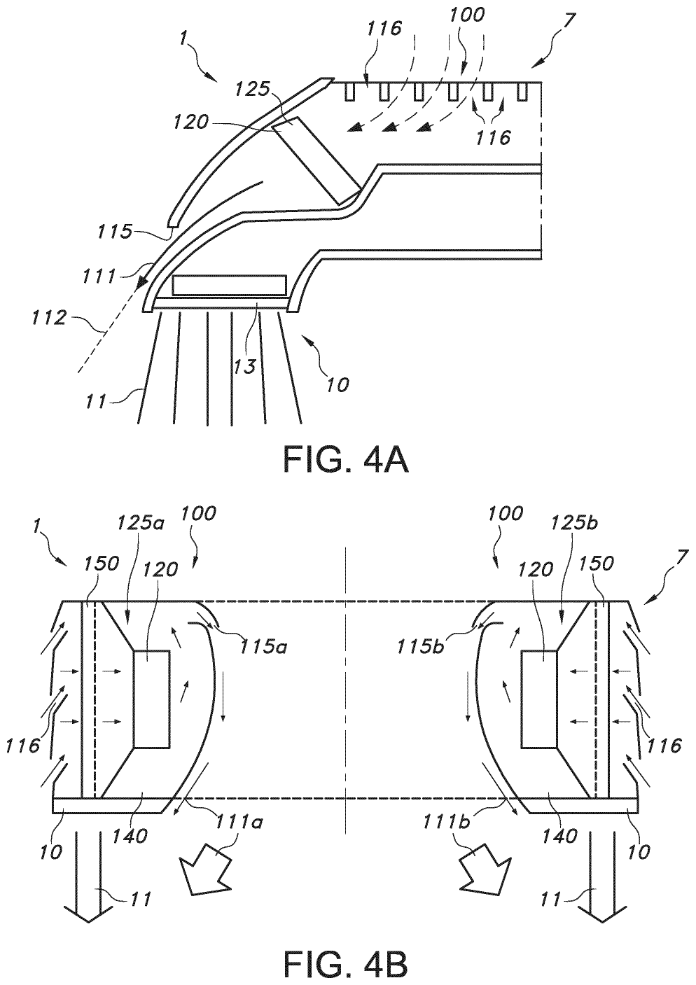

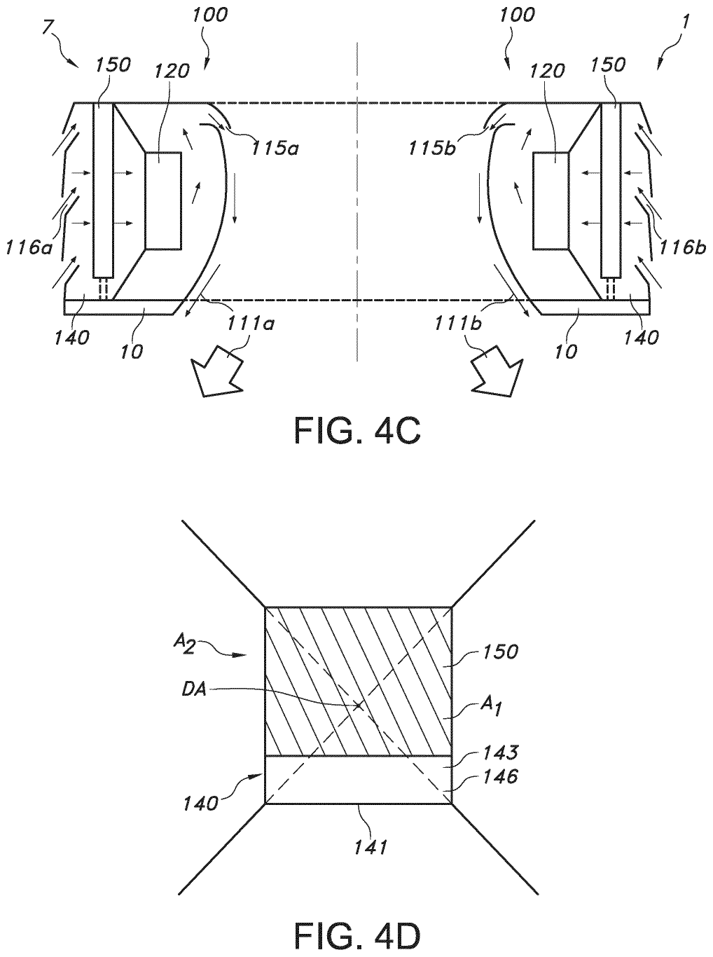

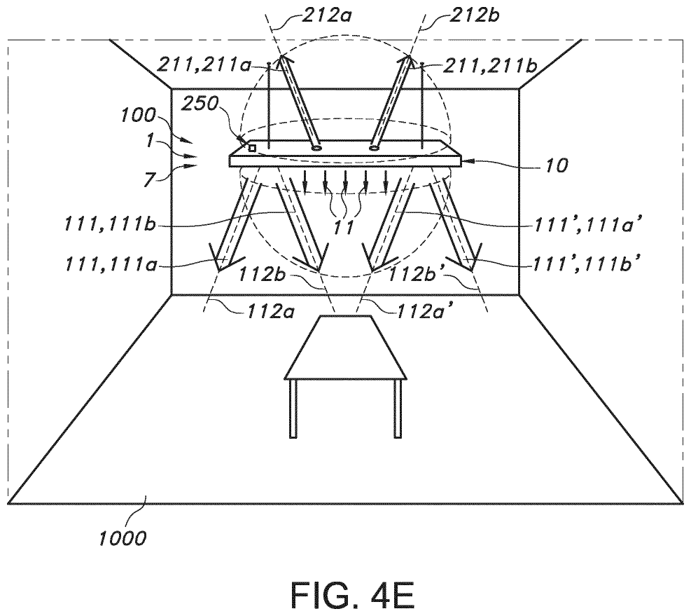

FIG. 4a schematically depicts part of a system 1, which may for instance be a part of the system 1 also schematically depicted in FIG. 3b. Reference 125 schematically indicates an impeller as example of an air flow generating device 120.

FIGS. 4b-4c schematically depict embodiments where the air flows 111 are generated at the inside of the system 1. In FIGS. 3b-3d the air flows were generated at the edges of the system 1. The fan assembly 100 comprises an air flow generating device 120, such as an impeller 125. The fan assembly 130 may comprise a duct 140 for a fluid connection between an air inlet 116 and one or more nozzle openings 115a, 115b, . . . . Here, the duct 140 comprises an air filter 150. Hence, in this way, with the “luminaire” also air may be purified. FIG. 4c schematically depicts an embodiment wherein the air filter 150 has an air filter cross-section A1, wherein the duct 140 has a duct cross-section A2 at a position 141 where the air filter 150 is configured, and wherein the filter cross-section A1 and the duct cross-section A2 have a ratio A1/A2 selected from the range of 0.3-0.95. This is schematically depicted in more detail in FIG. 4d, wherein the square indicates the cross section A2 of the duct 140 at position 141, wherein part of this cross section A2 is blocked by the filter 150 having a cross section A1, which is smaller than the cross section A2 of the duct 140. The ratio of A1/2 can also be larger than 0.95, such as even 1. In the latter variant, the filter is configured in the entire cross-section of the duct, and there is no bypass. When A1/A2 is larger than 0, but smaller than 1, there is some bypass or remaining part, indicated with reference 143, that can be used to increase the flow, but nevertheless air can be filtered and air in a space can be cleaned (removing of particles). The filter may optionally be configured as valve, thereby allowing a controllable ratio A1/2. Hence, the filter cross-section is especially the cross-section of the duct occupied by the filter (when seen along a duct axis). Alternatively or additionally, in embodiments, the ratio A1/A2 can be smaller than 1, and at least part of the remaining part, indicated with reference 143 of the duct can be closed with an controllable valve 146. This valve is optional. In this way, air filtering and air flow may even be better controlled. Hence, in embodiments the duct 140 can be intercepted by one or more of a valve and an air filter 150, wherein optionally stages are available wherein with a ratio of smaller than 1, nevertheless the bypass can be blocked with a valve. Hence, optionally the bypass is controllable. In FIG. 4b the cross-section of the air filter 150 and the duct 140 are at the position of the filter apparently substantially identical (no bypass). In FIG. 4d, reference DA indicates a duct axis, which is here perpendicular to the duct cross section A2.

Referring to FIGS. 3b-3d and 4a-4c, (a) the plurality of nozzle openings 115a, 115b, . . . perimetrically surround the annular light exit window 13 and/or the light source 10 or (b) wherein the plurality of nozzle openings 115a, 115b, . . . are perimetrically surrounded by the annular light exit window 13 and/or the light source 10.

Referring to FIGS. 3b, 4b, 4c, the embodiments schematically depicted therein and similar embodiments have a hollow inner part that can be illuminated, e.g. to create a specific ambiance

The system 1 can be used to illuminate a space, to provide one or more air flows in a space (such as for cooling), or to filter the air in the space. Especially, the system may thus be used for providing one or more of an air flow and light in a space 1000, the method comprising providing one or more of (a) one or more of said air flows 111a, 111b, . . . , and (b) said light source light 11 in said space 1000. This is schematically depicted in FIG. 4e. Here, by way of example the system 1 is configured pendant. Further, as schematically depicted in FIG. 4e, by way of example the system 1 comprises two subsets of mutually divergent air flows. Thereby, as here schematically depicted, air flows 111a and 111b, with mutually divergent directions 112a and 112b, respectively (which define a first virtual cone; not depicted), and air flows 111a′ and 111b′, with mutually divergent directions 112a′ and 112b′, respectively (which define a second virtual cone; not depicted) are provided. Further, by way of example also further air flows outside the virtual cones are provided in a direction anti parallel to the cone axes (not depicted) of the virtual cones. Here, the further air flow which are directed up are also provided. These further air flows are indicated with reference 211, with a first further air flow 211a, having a direction 212a, and a second further air flow 211b, with a direction 212b. The system, here especially housing 7, includes a sensor 250. Further, two virtual hemispheres are defined, with the device or apparatus (or housing) comprising the fan assembly 100 and the light source 10 in the middle. The mutually divergent air flows 111 and the light source light 11 are provided in the same hemisphere (here the lower).

The systems 1 shown in FIGS. 1a-1b, 3a-3c, 4a-4c and 4e all schematically depict integrated units, though in FIGS. 1a-1b the control system 200 and/or remote control are schematically depicted as not being part of the integrated unit (device or apparatus) comprising the fan assembly and light source. Note however that also in e.g. FIG. 4e the sensor 250 may be configure external from the device or apparatus comprising the fan assembly and light source

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The system, apparatus and devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A system (1) comprising a fan assembly with a plurality of nozzle openings for creating air flows, the fan assembly configured to provide said air flows in at least two non-parallel, divergent directions,
wherein the at least two non-parallel divergent directions are configured within a virtual cone having an apex angle selected from the range of 10-170° and having a cone axis, a control system configured to control said air flows, the system further comprising a light source configured to generate light source light,
wherein the airflow is at least twenty times larger than needed for cooling of the light source, preferably at least fifty times larger,
wherein the fan assembly comprises a plurality of independently controllable fan assemblies for providing guided, independently controlled jets of air into different directions from the plurality of nozzle openings,
wherein the light source comprises a hollow, annular light exit window perimetrically surrounding the plurality of nozzle openings, and
wherein the light source comprises a LED.

2. The system according to claim 1, wherein the control system is further configured to control the light source.

3. The system according to claim 1, wherein the light source light has an optical axis, wherein the system is configured to provide said light source light with the optical axis, of the light source light and the cone axis having a mutual angle selected from the ranges of 0-80° and 100-180°, and wherein the system is configured to provide said air flows having mutual angles with the cone axis selected from the ranges of 10-80°.

4. The system according to claim 1, comprising at least three nozzle openings, wherein the fan assembly is configured to provide at least three air flows in at least three mutually non-parallel directions, and wherein the control system is configured to control one or more of the flow velocity and flow rate of each of the at least three air flows escaping from the at least three nozzle openings.

5. The system according to claim 1, wherein the plurality of nozzle openings are configured in an annular configuration.

6. The system according to claim 1, wherein the system is free from moving parts.

7. The system according to claim 1, wherein the hollow, annular light exit window has a hollow inner part which widens in a downstream direction along the cone axis.

8. The system according to claim 1, wherein the system further comprises a sensor, wherein the control system is configured to control one or more of one or more of the air flows the light source light as function of a sensor signal of the sensor wherein the sensor is selected from the group consisting of a temperature sensor, an ambient light sensor, a humidity sensor, and an air quality sensor.

9. The system according to claim 1, wherein the fan assembly is configured to create air flows with a product of the air flow and the air velocity of at least 0.05 m4/s2 through the nozzle openings, wherein the nozzle openings have one or more dimensions selected from a length, a width and a diameter in the range of 0.2-10 mm, and wherein the fan assembly comprises one or more impellers.

10. The system according to claim 1, wherein the fan assembly comprises a duct for a fluid connection between an air inlets and one or more nozzle openings, wherein the ducts comprises an air filter.

11. The system according to claim 10, wherein the air filter has an air filter cross-section, wherein the duct has a duct cross-section at a position where the air filter is configured, and wherein the filter cross-section and the duct cross-section have a ratio selected from the range of 0.3-0.95.

12. The system according to claim 1, wherein the system is configured for suspension, wherein the system comprises a top part and a down part, wherein the light source is configured to provide said light source light propagating in a direction away from one or more of said top part and said down part, and wherein the fan assembly is configured to provide said air flows propagating in a direction away from said down part.

13. A method for providing one or more of an air flow and light in a space, the method comprising:
providing one or more of one or more of said air flows wherein the airflow is at least twenty times larger than needed for cooling of the light source, preferably at least fifty times larger, and said light source light in said space with the system according to claim 1, and
controlling the fan assembly comprising a plurality of independently controllable fan assemblies for providing guided, independently controlled jets of air into different direction from the plurality of nozzle openings.

14. The method according to claim 13, wherein the system further comprises said air filter.

15. The method according to claim 1, wherein the system is configured pendant.
